(19) United States
(12) Patent Application Publication
(10) Pub. No.: US 2018/0018971 A1
(43) Pub. Date: Jan. 18, 2018

(54) WORD EMBEDDING METHOD AND APPARATUS, AND VOICE RECOGNIZING METHOD AND APPARATUS

(71) Applicants: Samsung Electronics Co., Ltd., Suwon-si (KR); SNU R&DB FOUNDATION, Seoul (KR)

(72) Inventors: Hyoungmin PARK, Seoul (KR); Kyuseok SHIM, Seoul (KR); Woo In LEE, Seoul (KR); Kyoung Gu WOO, Seoul (KR); Wonkwang SHIN, Suwon-si (KR)

(73) Assignees: Samsung Electronics Co., Ltd., Suwon-si (KR); SNU R&DB FOUNDATION, Seoul (KR)

(21) Appl. No.: 15/642,547

(22) Filed: Jul. 6, 2017

(30) Foreign Application Priority Data
Jul. 15, 2016 (KR) 10-2016-0090206

(51) Int. Cl. G10L 17/18; G10L 17/04

(52) U.S. Cl. CPC G10L 17/18; G10L 17/04

(57) ABSTRACT

A word embedding and word embedding apparatus are provided. The word embedding method includes receiving an input sentence, detecting an unlabeled word in the input sentence, embedding the unlabeled word based on labeled words included in the input sentence, and outputting a feature vector based on the embedding.

### CROSS-REFERENCE TO RELATED APPLICATION(S)

This application claims the benefit under 35 USC §119(a) of Korean Patent Application No. 10-2016-0090206 filed on Jul. 15, 2016, in the Korean Intellectual Property Office, the entire disclosure of which is incorporated herein by reference for all purposes.

### BACKGROUND

### 1. Field

The following description relates to a word embedding method and apparatus, and a voice recognizing method and apparatus.

### 2. Description of Related Art

Technology for processing a user request by recognizing a voice of a user without an additional operation of inputting a command or activating a button has been provided in various electronic devices. The voice recognizing technology may pre-learn the voice of a user using a learning based model and recognize the pre-learned voice in response to a subsequent user request. An unseen word may appear in the learning model. It is difficult to understand the full meaning of a sentence including the unseen word.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, there is provided a word embedding method including receiving an input sentence, detecting an unlabeled word in the input sentence, embedding the unlabeled word based on labeled words included in the input sentence, and outputting a feature vector based on the embedding.

The embedding of the unlabeled word may include searching for at least one labeled word corresponding to the unlabeled word, and embedding the unlabeled word based on the at least one labeled word and labeled words of the input sentence.

The searching for the at least one labeled word may include searching for the at least one labeled word on the Internet or a dictionary database.

The searching for the at least one labeled word may include searching for the at least one labeled word on the Internet based on some of the labeled words in the input sentence.

The unlabeled word may include words other than the labeled words corresponding to a feature vector from among words of the input sentence.

The detecting of the unlabeled word may include identifying a feature vector corresponding to words of the input sentence, and detecting a word of the input sentence as the unlabeled word, in response to a feature vector corresponding the word not being obtained.

The identifying of the feature vector may include identifying the feature vector of a predetermined type corresponding to the words of the input sentence by applying each word of the input sentence to a first model including a neural network.

The embedding of the unlabeled word may include embedding the unlabeled word by applying the unlabeled word to a second model distinguishable from the first model.

The embedding of the unlabeled word may include searching for sentences similar to the input sentence based on the labeled words, and embedding the unlabeled word based on a sentence having a greatest similarity from among the similar sentences.

The embedding of the unlabeled word may include embedding the unlabeled word based on a context of the input sentence.

The embedding of the unlabeled word may include embedding the unlabeled word based on a relationship between labeled words of the input sentence.

The embedding of the unlabeled word may include searching for sentences similar to the input sentence based on the labeled words, extracting at least one similar sentence having a similarity greater than a threshold from among the similar sentences, and embedding the unlabeled word based on the at least one similar sentence.

The extracting of the at least one similar sentence may include extracting the at least one similar sentence having the similarity greater than the threshold by order of similarity.

The embedding of the unlabeled word may include detecting a feature vector corresponding to the unlabeled word using a lookup table that stores pre-generated feature vectors corresponding to unlabeled words.

In another general aspect, there is provided a voice recognizing method including generating an input sentence by recognizing a voice, detecting an unlabeled word in the input sentence, obtaining first feature vectors corresponding to labeled words in the input sentence, obtaining a second feature vector corresponding to the unlabeled word based on the first feature vectors, and generating interpretation information corresponding to the input sentence based on the first feature vectors and the second feature vector.

The detecting of the unlabeled word may include detecting a word included in the input sentence as the unlabeled word, in response to a first feature vector corresponding to the word not being obtained.

The obtaining of the first feature vectors may include obtaining the first feature vector corresponding to each word of the input sentence by applying the labeled words included in the input sentence to a first model including a neural network.

The obtaining of the second feature vector may include embedding the unlabeled word by applying the unlabeled word to a second model distinguishable from the first model, based on the first feature vectors.

In another general aspect, there is provided a word embedding apparatus including a transceiving interface configured to receive an input sentence, and a processor configured to detect an unlabeled word included in the input sentence and to embed the unlabeled word based on labeled words included in the input sentence, wherein the transceiving interface is further configured to output a feature vector based on the embedding.

The processor may be configured to search for at least one labeled word corresponding to the unlabeled word on the Internet or a dictionary database and to embed the unlabeled word based on the retrieved at least one labeled word and the labeled words in the input sentence.

The processor may be configured to obtain a feature vector corresponding to each word in the input sentence and to detect a word in the input sentence as the unlabeled word, in response to the feature vector corresponding the word not being obtained.

In another general aspect, there is provided a voice recognizing apparatus including a sentence generator configured to generate an input sentence by recognizing a voice, a word embeder configured to detect an unlabeled word in the input sentence, to obtain first feature vectors corresponding to labeled words in the input sentence, and to obtain a second feature vector corresponding to the unlabeled word based on the first feature vectors, and a processor configured to generate interpretation information corresponding to the input sentence based on the first feature vectors and the second feature vector.

In another general aspect, there is provided a digital device including an antenna, a cellular radio configured to transmit and receive data via the antenna according to a cellular communications standard, a touch-sensitive display, a memory configured to store instructions, and a processor configured to execute the instructions to detect an input sentence through the cellular radio, to detect an unlabeled word in the input sentence, to obtain first feature vectors corresponding to labeled words in the input sentence, to obtain a second feature vector corresponding to the unlabeled word based on the first feature vectors, and to display interpretation information on the touch-sensitive display corresponding to the input sentence based on the first feature vectors and the second feature vector.

Other features and aspects will be apparent from the following detailed description, the drawings, and the claims.

### BRIEF DESCRIPTION OF THE DRAWINGS

FIG. 1 is a diagram illustrating an example of an environment in which a word embedding method is performed.

FIG. 2 is a diagram illustrating an example of a word embedding process.

FIG. 3 is a diagram illustrating an example of a word embedding method.

FIG. 4 is a diagram illustrating an example of a method of detecting an unlabeled word included in an input sentence.

FIGS. 5 and 6 are diagrams illustrating examples of a method of embedding an unlabeled word.

FIG. 7 is a diagram illustrating an example of a word embedding method.

FIG. 8 is a diagram illustrating an example of pre-learning an unseen word in an offline environment.

FIG. 9 is a diagram illustrating an example of a voice recognizing method.

FIG. 10 is a diagram illustrating an example of a word embedding apparatus.

FIG. 11 is a diagram illustrating an example of a word embedding apparatus.

FIG. 12 is a diagram illustrating an example of a voice recognizing apparatus.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or apparatuses described herein. However, various changes, modifications, and equivalents of the methods, apparatuses, and/or apparatuses described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or apparatuses described herein that will be apparent after an understanding of the disclosure of this application.

Particular structural or functional descriptions of examples are intended for the purpose of describing examples and the examples may be implemented in various forms and should not be construed as being limited to those described in the present disclosure.

Although terms of “first” or “second” are used to explain various components, the components are not limited to the terms. These terms are used only to distinguish one component from another component. For example, a “first” component may be referred to as a “second” component, or similarly, the “second” component may be referred to as the “first” component within the scope of the right according to the concept of the present disclosure.

Words describing relative spatial relationships, such as “below”, “beneath”, “under”, “lower”, “bottom”, “above”, “over”, “upper”, “top”, “left”, and “right”, may be used to conveniently describe spatial relationships of one device or elements with other devices or elements. It will be understood that the spatially relative terms are intended to encompass different orientations of the device in use or operation in addition to the orientation depicted in the figures. For example, if the device in the figures is turned over, elements described as “above,” or “upper” other elements would then be oriented “below,” or “lower” the other elements or features. Thus, the term “above” can encompass both the above and below orientations depending on a particular direction of the figures. The device may be otherwise oriented (rotated 90 degrees or at other orientations) and the spatially relative descriptors used herein may be interpreted accordingly.

Unless indicated otherwise, it will be understood that when a first element, such as a layer, region or wafer (substrate), is referred to as being “on,” “connected to,” “joined to” or “coupled to” a second element, it can cover both a case where the first element directly contacts the second element, and a case where one or more other elements are disposed between the first element and the second element. When an element is referred to as being “directly on,” “directly connected to,” or “directly coupled to” another element, there may be no elements or layers between the two elements. Likewise, expressions, for example, “between” and “immediately between” and “adjacent to” and “immediately adjacent to” may also be construed as described in the foregoing.

As used herein, the singular forms are intended to include the plural forms as well, unless the context clearly indicates otherwise.

In an example, the voice recognizing apparatus may be embedded in or interoperate with various digital devices such as, for example, a mobile phone, a cellular phone, a smart phone, a personal computer (PC), a laptop, a notebook, a subnotebook, a netbook, or an ultra-mobile PC (UMPC), a tablet personal computer (tablet), a phablet, a mobile internet device (MID), a personal digital assistant (PDA), an enterprise digital assistant (EDA), a digital camera, a digital video camera, a portable game console, an MP3 player, a portable/personal multimedia player (PMP), a handheld e-book, an ultra mobile personal computer (UMPC), a portable lab-top PC, a global positioning system (GPS) navigation, a personal navigation device or portable navigation device (PND), a handheld game console, an e-book, and devices such as a television, a high definition television (HDTV), an optical disc player, a DVD player, a Blue-ray player, a setup box, robot cleaners, a home appliance, content players, communication systems, image processing systems, graphics processing systems, other consumer electronics/information technology (CE/IT) device, or any other device capable of wireless communication or network communication consistent with that disclosed herein. The digital devices may be may be embedded in or interoperate with a smart appliance, an autonomous vehicle, an intelligent vehicle, an electric vehicle, a hybrid vehicle, a smart home environment, or a smart building environment.

The digital devices may also be implemented as a wearable device, which is worn on a body of a user. In one example, a wearable device may be self-mountable on the body of the user, such as, for example, a ring, a watch, a pair of glasses, glasses-type device, a bracelet, an ankle bracket, a belt, a necklace, an earring, a headband, a helmet, a device embedded in the cloths, or as an eye glass display (EGD), which includes one-eyed glass or two-eyed glasses. In another non-exhaustive example, the wearable device may be mounted on the body of the user through an attaching device, such as, for example, attaching a smart phone or a tablet to the arm of a user using an armband, incorporating the wearable device in a cloth of the user, or hanging the wearable device around the neck of a user using a lanyard. The digital devices may be used to provide a rapid and accurate result of word embedding when an unseen word is input. Hereinafter, the unseen word is also referred to as a word that is not learned in advance.

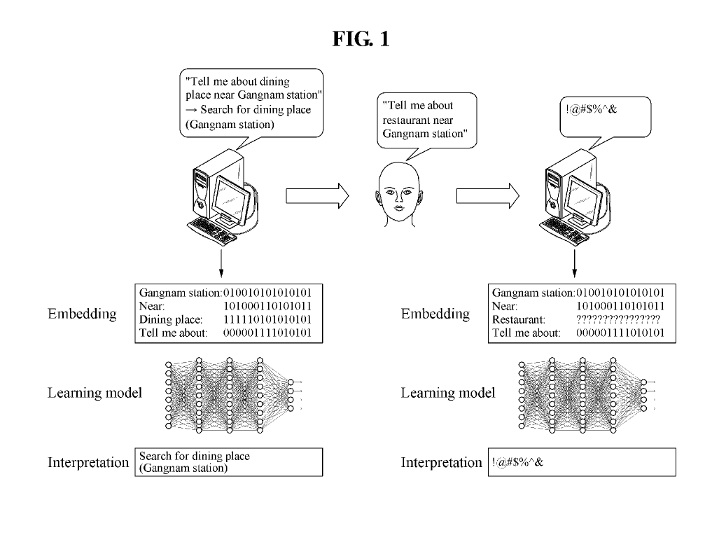

FIG. 1 is a diagram illustrating an example of an environment in which a word embedding method is performed. FIG. 1 illustrates an example of a result of processing a sentence including an unlearned word by a voice recognizing apparatus.

For example, when the voice recognizing apparatus has pre-learned a first sentence “tell me about dining place near Gangnam station” and a user utters a second sentence “tell me about restaurant near Gangnam station” the voice recognizing apparatus performs processes described below.

Words, for example, “Gangnam station”, “near”, “dining place”, and “tell”, included in the first sentence are pre-known words that are applied to a learning model, that is, words having feature vectors corresponding to the words. In an example, the voice recognizing apparatus interprets a meaning of the first sentence based on the feature vectors corresponding to the words. The learning model may include a neural network (NN).

To evaluate a word order or a grammatical feature of a language, the NN may define a label of a training feature vector to receive an input of feature vectors that represent input words by a unit of a sentence, a phrase or a clause. The NN may output the feature vectors that represent estimation words by a unit of a phrase or a clause. A word having a feature vector is referred to as a labeled word indicating that a label of the feature vector is defined. The feature vector is a representation of a predetermined word. In an example, the feature vector is a real number vector, such as, (3.432, 4.742, . . . , 0.299) or (0,1,0,1,0, 1,0). Representing a word in a natural language based on a vector space of real numbers is referred to as word embedding.

Even though the second sentence is similar to the first sentence, the second sentence includes the word “restaurant” instead of the word “dining place”. The word “restaurant” being an unseen word, the voice recognizing apparatus may be unable to interpret the second sentence because the feature vector corresponding to the word “restaurant” does not exist. The unseen word is also referred to as an unlabeled word indicating that the pre-generated feature vector is not labeled through learning.

In an example, similarly to the way the second sentence is handled, the word embedding is performed on the unseen word or the sentence including the unseen word using a separate model that generates a vector of the unseen word. In an example, an effective embedding method for the unseen word is provided by using a sentence or a word detected through another search process, such as a web search process. The model that generates the vector of the unseen word may include, for example, a recurrent neural network (RNN), a convolutional neural network (CNN), and a bidirectional RNN.

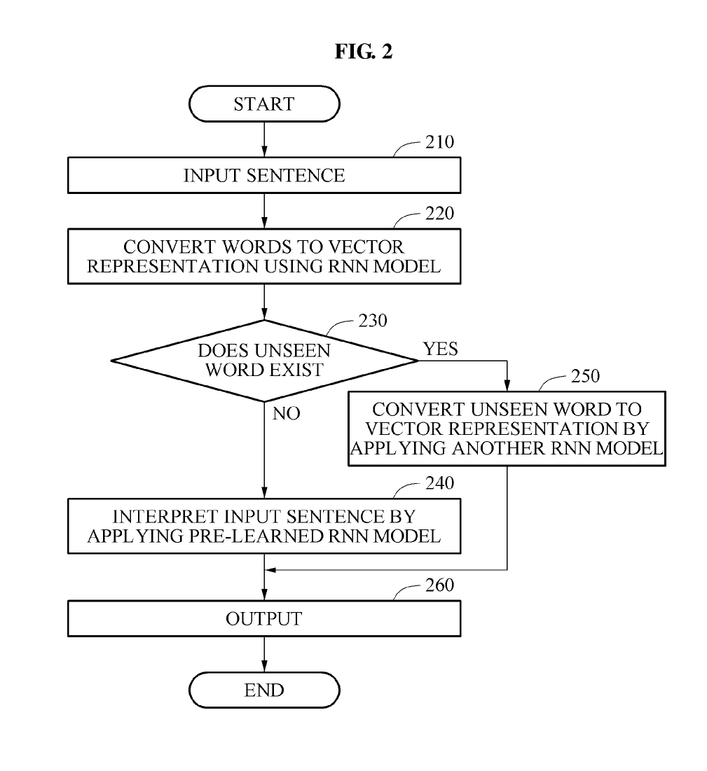

FIG. 2 is a diagram illustrating an example of a word embedding process. FIG. 2 illustrates an operation of a word embedding apparatus, hereinafter referred to as an embedding apparatus, in a case where an unseen word is included in an input sentence. The operations in FIG. 2 may be performed in the sequence and manner as shown, although the order of some operations may be changed or some of the operations omitted without departing from the spirit and scope of the illustrative examples described. Many of the operations shown in FIG. 2 may be performed in parallel or concurrently. In addition to the description of FIG. 2 below, the above descriptions of FIG. 1, are also applicable to FIG. 2, and are incorporated herein by reference. Thus, the above description may not be repeated here.

In 210, a sentence is input by a user, another apparatus, or a digital device. In 220, the embedding apparatus converts words included in the sentence to vector representations using a pre-learned neural network model. In an example, the embedding apparatus converts each of the words included in the sentence to a vector value or a feature vector embedded by, for example, the pre-learned neural network model. In an example, the neural network model includes, for example, a recurrent neural network (RNN).

In 230, the embedding apparatus determines whether the unseen word exists in the sentence. In 240, based on a result of the determination that unseen word does not exist in the sentence, the embedding apparatus interprets the input sentence by applying the pre-learned neural network model used in 220. In 260, the embedding apparatus outputs a result of the interpretation performed in operation 240.

In 250, based on the result of the determination that the unseen word exists in the sentence, the embedding apparatus converts the unseen word or the sentence including the unseen word to the vector representation by applying a separate neural network model. In an example, the separate neural network model determines the vector representation corresponding to the unseen word. In 260, the embedding apparatus outputs the converted vector representation.

In an example, the embedding apparatus identifies, in advance, feature vectors for remaining words when the sentence only including the remaining words excluding the unseen word. Thus, the embedding apparatus may process the unseen word to have the most similar feature vector corresponding to a meaning of the unseen word based on a context of the sentence.

Accordingly, when the feature vector corresponding to the unseen word is converted to the feature vector corresponding to a contextually similar meaning to that of the unseen word, the meaning of the unseen word may be ambiguous based only on one sentence including the unseen word. Thus, in an example, the embedding apparatus performs sentence embedding by searching for a sentence(s) similar to the sentence including the unseen word. When searching for similar sentences, the embedding apparatus extracts a sentence most similar to the input sentence based on a threshold. In an example, the threshold is predetermined. The embedding apparatus may output, in real time, the feature vector corresponding to a result of the embedding of the unseen word by applying the input sentence including the unseen word and the similar sentences retrieved from the Internet to the separate neural network model.

The embedding apparatus may enhance accuracy of the neural network model and the feature vectors by extracting various sentences including the unseen word from the Internet. In an example, the embedding apparatus again extracts the sentence considered to have the most similar meaning based on the threshold. In an example, the feature vector having the most contextually similar meaning to that of the unseen word is output through the aforementioned processes.

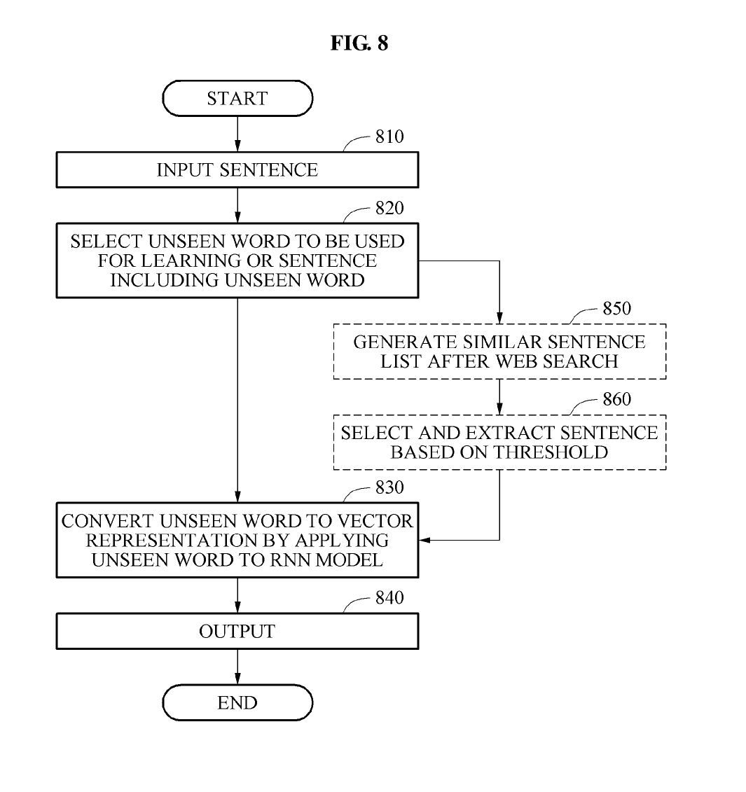

In an example, a process of embedding the unseen word is performed in real time. However, it may be difficult to use a real-time web search process due to response time, which may be significant. In an example, the feature vector corresponding to the unseen word is pre-generated offline, such that response time is shorter by applying the pre-generated feature vector to the unseen word when the unseen word actually appears. An example performed when it is difficult to use the real-time web search process will be described with reference to FIG. 8.

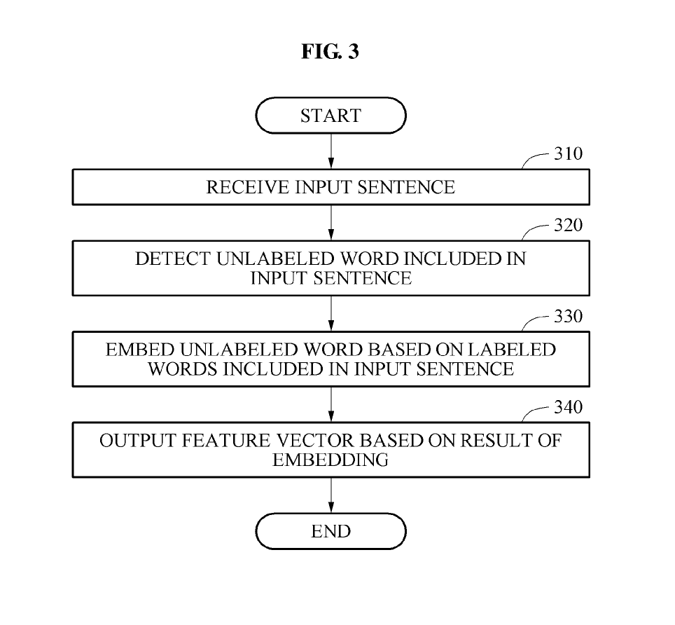

FIG. 3 is a diagram illustrating an example of a word embedding method. The operations in FIG. 3 may be performed in the sequence and manner as shown, although the order of some operations may be changed or some of the operations omitted without departing from the spirit and scope of the illustrative examples described. Many of the operations shown in FIG. 3 may be performed in parallel or concurrently. In addition to the description of FIG. 3 below, the above descriptions of FIGS. 1-2, are also applicable to FIG. 3, and are incorporated herein by reference. Thus, the above description may not be repeated here.

Referring to FIG. 3, in 310, an embedding apparatus receives an input sentence. In an example example, the embedding apparatus receives the input sentence from a user, a separate voice converting apparatus, or a digital device.

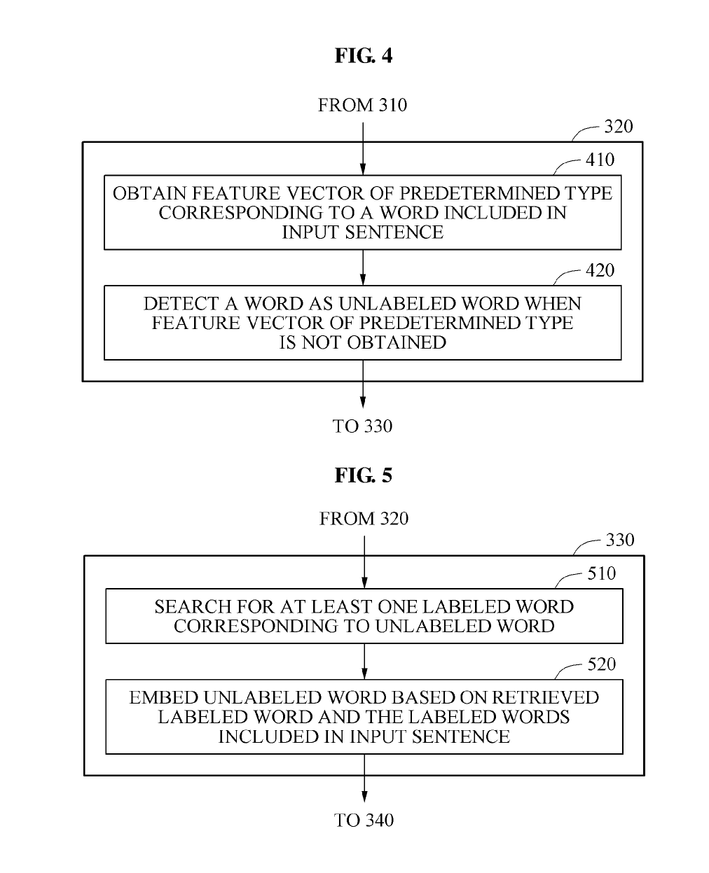

In 320, the embedding apparatus detects an unlabeled word included in the input sentence. The unlabeled word includes remaining words excluding a labeled word corresponding to a feature vector of a predetermined type from among a plurality of words included in the input sentence. In an example, the feature vector of the predetermined type is a distributional vector or a one-hot vector. The method of detecting the unlabeled word by the embedding apparatus will be described with reference to FIG. 4.

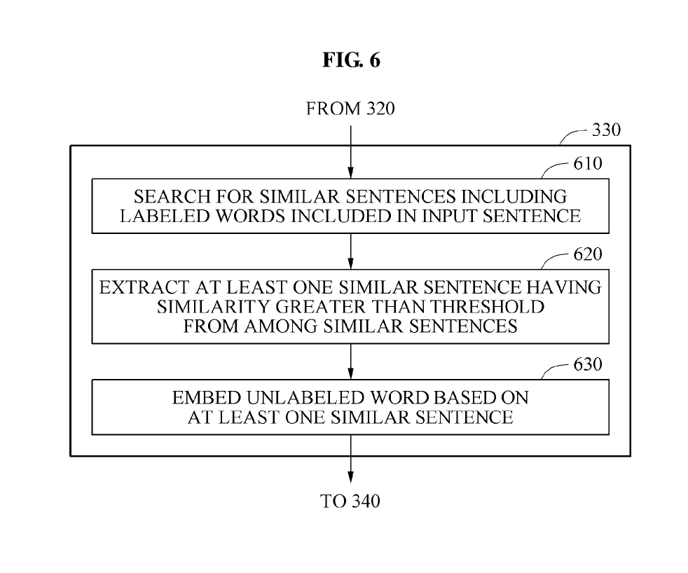

In 330, the embedding apparatus embeds the unlabeled word based on labeled words included in the input sentence. The method of embedding the unlabeled word by the embedding apparatus will be described with reference to FIGS. 5 and 6.

In 340, the embedding apparatus outputs the feature vector based on a result of the embedding.

FIG. 4 is a diagram illustrating an example of a method of detecting an unlabeled word included in an input sentence. The operations in FIG. 4 may be performed in the sequence and manner as shown, although the order of some operations may be changed or some of the operations omitted without departing from the spirit and scope of the illustrative examples described. Many of the operations shown in FIG. 4 may be performed in parallel or concurrently. In addition to the description of FIG. 4 below, the above descriptions of FIGS. 1-3, are also applicable to FIG. 4, and are incorporated herein by reference. Thus, the above description may not be repeated here.

Referring to FIG. 4, in 410, an embedding apparatus obtains a feature vector of a predetermined type corresponding to each word included in the input sentence. In an example, the embedding apparatus obtains the feature vector of the predetermined type corresponding to each of the words by applying each of the words to a first model including a neural network. In an example, the first model is a recurrent neural network (RNN), and may be learned in advance.

When the feature vector of the predetermined type is not obtainable in 410, in 420, the embedding apparatus detects word as an unlabeled word.

FIG. 5 is a diagram illustrating an example of a method of embedding an unlabeled word. The operations in FIG. 5 may be performed in the sequence and manner as shown, although the order of some operations may be changed or some of the operations omitted without departing from the spirit and scope of the illustrative examples described. Many of the operations shown in FIG. 5 may be performed in parallel or concurrently. In addition to the description of FIG. 5 below, the above descriptions of FIGS. 1-4, are also applicable to FIG. 5, and are incorporated herein by reference. Thus, the above description may not be repeated here.

Referring to FIG. 5, in 510, an embedding apparatus searches for at least one labeled word corresponding to an unlabeled word. In an example, the embedding apparatus searches for the at least one labeled word corresponding to the unlabeled word on the Internet or search for the at least one labeled word corresponding to the unlabeled word on a pre-stored dictionary database.

In 520, the embedding apparatus embeds the unlabeled word based on the retrieved at least one labeled word and labeled words included in an input sentence. In an example, the embedding apparatus enhances the embedding accuracy when a feature vector corresponding to the unlabeled word to corresponds to a contextually similar meaning to that of the unlabeled word by embedding the unlabeled word based on the retrieved at least one labeled word and the labeled words included in the input sentence.

FIG. 6 is a diagram illustrating another example of a method of embedding an unlabeled word. The operations in FIG. 6 may be performed in the sequence and manner as shown, although the order of some operations may be changed or some of the operations omitted without departing from the spirit and scope of the illustrative examples described. Many of the operations shown in FIG. 6 may be performed in parallel or concurrently. In addition to the description of FIG. 6 below, the above descriptions of FIGS. 1-5, are also applicable to FIG. 6, and are incorporated herein by reference. Thus, the above description may not be repeated here.

Referring to FIG. 6, in 610, an embedding apparatus searches for similar sentences including labeled words included in an input sentence. The embedding apparatus may search for the similar sentences including the labeled words included in the input sentence on the Internet or a pre-stored dictionary database. In an example, the embedding apparatus searches for the similar sentences including all the labeled words included in the input sentence, or searches for the similar sentences including some of the labeled words.

In 610, the embedding apparatus searches for the sentences similar to the input sentence using a similarity determining method, such as, for example, a Jaccard coefficient method, an edit distance method, and a hash function method. The Jaccard coefficient is obtained by digitizing a degree of similarity between two objects, for example, sentences. As a value of the Jaccard coefficient increases, the degree of similarity between two sentences is determined to be high. The edit distance method is also referred to as a Levenshtein distance algorithm. The edit distance method is a method of identifying a degree of similarity between two character strings. For example, the edit distance method determines a degree of similarity between a character string A and a character string B by calculating a number of operations used to make the character string A identical to the character string B. The edit distance method may perform an operation, for example, insertion, addition, deletion, and replacement. The hash function method is used to determine a similarity between the two sentences based on a similarity between hash function values of the two sentences. Threshold values for the similarity determining methods may be set to be different. The threshold values may be referred to as references of the similarities.

In 620, the embedding apparatus extracts at least one similar sentence having a similarity greater than a threshold from among the similar sentences retrieved in 610. In an example, the threshold is preset. The threshold may be differently set based on the similarity determining methods that are used. In an example, the embedding apparatus extracts the at least one similar sentence having the similarity greater than the threshold by order of similarity.

In 630, the embedding apparatus embeds an unlabeled word based on the at least one similar sentence. For example, the embedding apparatus embeds the unlabeled word by applying the at least one similar sentence to a second model, different than a first model. The second model may include, for example, a neural network that estimates a meaning of a word based on at least one of a context of the input sentence and/or a relationship between words included in the input sentence. For example, the second model may include a neural network such as, for example, recurrent neural network (RNN), a convolutional neural network (CNN), and a bidirectional RNN. In an example, the embedding apparatus embeds the unlabeled word using at least some of words included in at least one sentence.

In an example, the embedding apparatus searches for the similar sentences including the labeled words included in the input sentence and embeds the unlabeled word based on a most similar sentence having a maximum similarity from among the similar sentences.

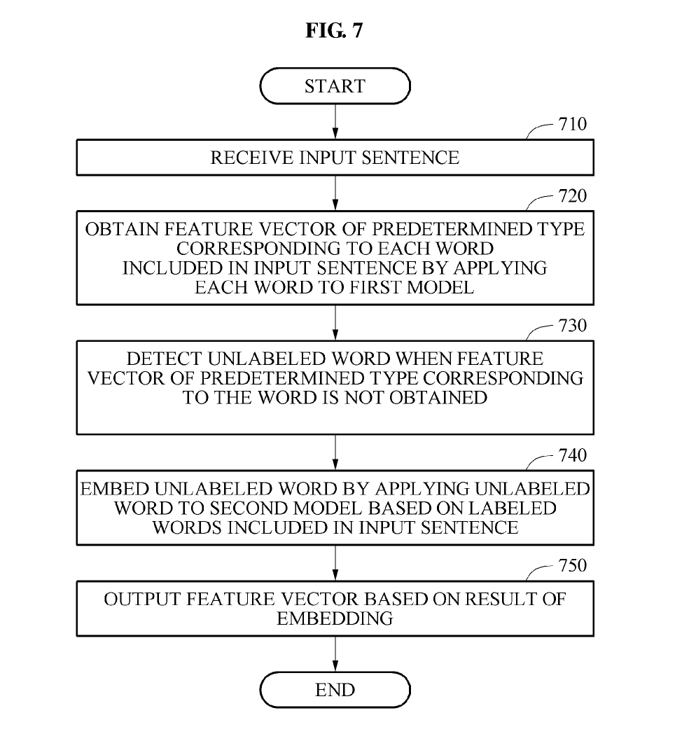

FIG. 7 is a diagram illustrating another example of a word embedding method. The operations in FIG. 7 may be performed in the sequence and manner as shown, although the order of some operations may be changed or some of the operations omitted without departing from the spirit and scope of the illustrative examples described. Many of the operations shown in FIG. 7 may be performed in parallel or concurrently. In addition to the description of FIG. 7 below, the above descriptions of FIGS. 1-6, are also applicable to FIG. 7, and are incorporated herein by reference. Thus, the above description may not be repeated here.

In 710, an embedding apparatus receives an input sentence. In 720, the embedding apparatus obtains a feature vector of a predetermined type corresponding to each word included in the input sentence by applying each word to a first model including a neural network.

In 730, the embedding apparatus detects each word as an unlabeled word when the feature vector of the predetermined type corresponding to the word is not obtained.

In 740, the embedding apparatus embeds the unlabeled word by applying the unlabeled word to a second model distinguishable from the first model based on labeled words included in the input sentence.

In 750, the embedding apparatus outputs the feature vector based on a result of the embedding.

FIG. 8 is a diagram illustrating an example of pre-learning an unseen word in an offline environment. The operations in FIG. 8 may be performed in the sequence and manner as shown, although the order of some operations may be changed or some of the operations omitted without departing from the spirit and scope of the illustrative examples described. Many of the operations shown in FIG. 8 may be performed in parallel or concurrently. In addition to the description of FIG. 8 below, the above descriptions of FIGS. 1-7, are also applicable to FIG. 8, and are incorporated herein by reference. Thus, the above description may not be repeated here.

When an unseen word (unlabeled word) is pre-learned in a neural network in the offline environment, an embedding apparatus may know a condition, for example, a contextual meaning, associated with the unseen word. In an example, the embedding apparatus generates a feature vector corresponding to the unseen word and a similar sentence corresponding to the unseen word in an offline environment through a web search process. Thus, the embedding apparatus may shorten a response time by applying, without making a change, the pre-generated feature vector to the unseen word included in an actual input sentence when the unseen word appears in the actual input sentence.

When a word is identified as an unseen word during learning in the offline environment, a web search may be performed. The web search may retrieve an unseen word different from the unseen word identified during learning in the offline environment. After the learning is completed, the embedding apparatus may pre-generate a lookup table by pre-calculating feature vectors for embedding the unseen word different from the unseen word identified during learning in the offline environment.

For example, the embedding apparatus may detect a feature vector corresponding to an unlabeled word using the lookup table that stores pre-generated feature vectors corresponding to a plurality of unlabeled words.

Referring to FIG. 8, a sentence is input in 810. In 820, the embedding apparatus selects an unseen word to be used for learning or a sentence including the unseen word. In 830, the embedding apparatus converts the unseen word to be used for learning to a vector representation by applying the unseen word to a recurrent neural network (RNN) model. In 840, the embedding apparatus outputs the vector representation.

In 850, when a sentence including an unlabeled word to be used for learning is selected, the embedding apparatus generates a sentence list including sentences similar to the selected sentence after a web search has been performed. In 860, the embedding apparatus selects and extracts a sentence most similar to the selected sentence based on a threshold. In an example, the threshold is preset. In 830, the embedding apparatus converts the unlabeled word to the vector representation by applying the most similar sentence to the RNN model.

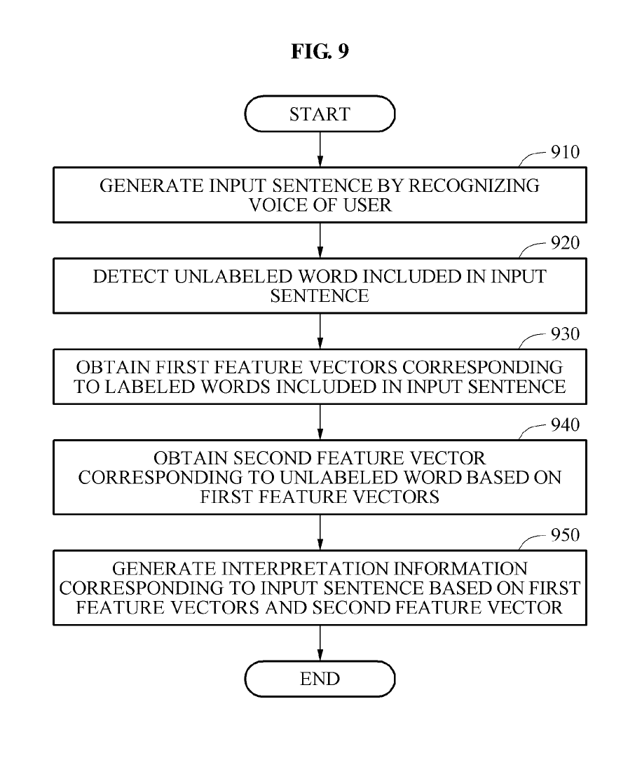

FIG. 9 is a diagram illustrating an example of a voice recognizing method. Referring to FIG. 9, a voice recognizing process using a word embedding method is illustrated. The operations in FIG. 9 may be performed in the sequence and manner as shown, although the order of some operations may be changed or some of the operations omitted without departing from the spirit and scope of the illustrative examples described. Many of the operations shown in FIG. 9 may be performed in parallel or concurrently. In addition to the description of FIG. 9 below, the above descriptions of FIGS. 1-8, are also applicable to FIG. 9, and are incorporated herein by reference. Thus, the above description may not be repeated here.

In 910, a voice recognizing apparatus generates an input sentence by recognizing a voice of a user.

In 920, the voice recognizing apparatus detects an unlabeled word included in the input sentence. For example, the voice recognizing apparatus may detect a word included in the input sentence as unlabeled when a first feature vector of a predetermined type corresponding to the word is not obtainable.

In 930, the voice recognizing apparatus obtains first feature vectors corresponding to labeled words included in the input sentence. The voice recognizing apparatus may obtain the first feature vector of the predetermined type corresponding to each of the words by applying the labeled words included in the input sentence to a first model including a neural network.

In 940, the voice recognizing apparatus obtains a second feature vector corresponding to the unlabeled word based on the first feature vectors. The voice recognizing apparatus may obtain the second feature vector by embedding the unlabeled word by applying the unlabeled word to a second model distinguishable from the first model based on the first feature vectors.

In 950, the voice recognizing apparatus generates interpretation information corresponding to the input sentence based on the first feature vectors and the second feature vector. In an example. the interpretation information mais natural language interpretation information identifiable by a machine.

The embedding methods described with reference to FIGS. 2 through 8 are also used by the voice recognizing apparatus.

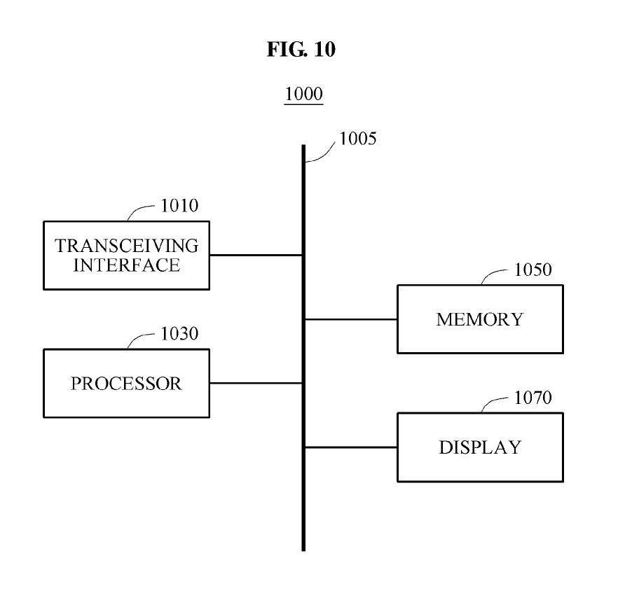

FIG. 10 is a diagram illustrating an example of a word embedding apparatus 1000. Referring to FIG. 10, a word embedding apparatus 1000 includes a transceiving interface 1010, a processor 1030, a display 1070, and a memory 1050. In an example, the transceiving interface 1010, the processor 1030, the display 1070, and the memory 1050 is connected with each other via a communication bus 1005.

The transceiving interface 1010 receives an input sentence. The transceiving interface 1010 outputs a feature vector based on a result of embedding performed by the processor 1030.

The processor 1030 detects an unlabeled word included in the input sentence, and embeds the unlabeled word based on labeled words included in the input sentence.

The processor 1030 searches for at least one labeled word corresponding to the unlabeled word on the Internet or a pre-stored dictionary database. The processor 1030 embeds the unlabeled word based on the retrieved labeled word and the labeled words included in the input sentence.

The processor 1030 obtains a feature vector of a predetermined type corresponding to each of a plurality of words included in the input sentence. The processor 1030 detects the each of the words as the unlabeled word in response to the feature vector of the predetermined type corresponding to each of the words not being obtained.

The processor 1030 also performs at least one of the methods described with reference to FIGS. 1 through 9. The processor 1030 executes a program and controls the word embedding apparatus 1000. In an example, the program code executed by the processor 1030 is stored in the memory 1050.

The memory 1050 stores the feature vector based on a result of the embedding. The memory 1050 stores the at least one labeled word corresponding to the unlabeled word retrieved from the Internet or the pre-stored dictionary database. The memory 1050 stores various pieces of information generated during processing by the processor 1030. In an example, the memory 1050 stores information received through the transceiving interface 1010.

The memory 1050 stores data and programs. The memory 1050 includes a volatile memory and a non-volatile memory. The memory 1050 includes a large volume storage, such as, a hard disk to store various pieces of data. For example, the memory 1050 includes a dictionary database using at least one hard disk and various similar words are stored in the dictionary database.

In an example, the interpreted meaning of the input sentence, received by the transceiving interface 1010 is displayed on the display 1070. In an example, the display 1070 may be a physical structure that includes one or more hardware components that provide the ability to render a user interface and/or receive user input. The display 1070 can encompass any combination of display region, gesture capture region, a touch sensitive display, and/or a configurable area. In an example, the display 1070 can be embedded in the word embedding apparatus 1000. In an example, the display 1070 is an external peripheral device that may be attached to and detached from the word embedding apparatus 1000. The display 1070 may be a single-screen or a multi-screen display. A single physical screen can include multiple displays that are managed as separate logical displays permitting different content to be displayed on separate displays although part of the same physical screen. The display 1070 may also be implemented as an eye glass display (EGD), which includes one-eyed glass or two-eyed glasses.

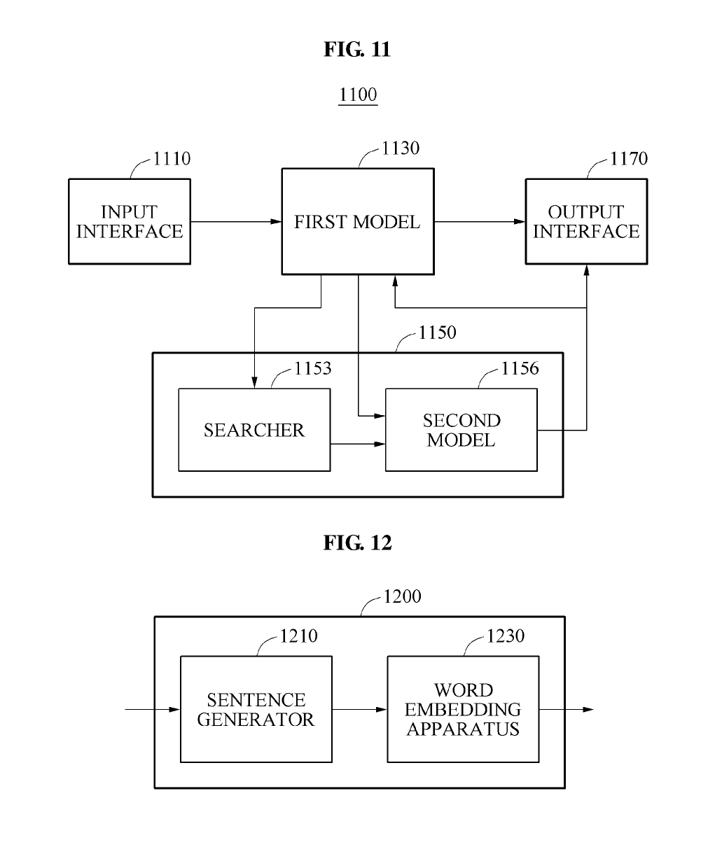

FIG. 11 is a diagram illustrating another example of a word embedding apparatus. Referring to FIG. 11, a word embedding apparatus 1100 includes an input interface 1110, a first model 1130, an embedding processor 1150, and an output interface 1170. The embedding processor 1150 includes a searcher 1153 and a second model 1156.

When the input sentence is received through the input interface 1110, the word embedding apparatus 1100 generates a representation of the input sentence by applying a feature vector defined in the first model 1130 to each word included in the sentence.

In an example, when all of the words included in the sentence are embedded and the feature vector exists, the word embedding apparatus 1100 outputs the existing feature vector through the output interface 1170. In an example, when an unseen word, which is not embedded, i.e., an unlabeled word, is included in the sentence, the word embedding apparatus 1100 determines or selects an appropriate feature vector corresponding to the unlabeled word. The word embedding apparatus 1100 may determine the appropriate feature vector corresponding to the unlabeled word based on a separate second model 1156.

When the unlabeled word exists in the input sentence, the word embedding apparatus 1100 may utilize context information and effectively perform word embedding on the unlabeled word by applying the unlabeled word to the separate second model 1156.

When the word embedding is performed on the unlabeled word using only the sentence including the unlabeled word, a meaning of the word may be ambiguous. Thus, the word embedding apparatus 1100 may additionally use a similar word retrieved from the Internet when performing word embedding. The searcher 1153 extracts and searches for the similar sentence by searching for the unlabeled word or the sentence including the unlabeled word on the Internet. The embedding processor 1150 embeds the unlabeled word by applying the extracted similar sentence (or the unlabeled word and the labeled word included in the extracted similar sentence) and the input sentence (or the unlabeled word included in the input sentence) to the second model 1156 distinguishable from the first model 1130.

The output interface 1170 outputs the feature vector based on a result of the embedding of the unlabeled word. The embedding processor 1150 provides, for the first model 1130, the feature vector based on the result of the embedding of the unlabeled word.

FIG. 12 is a diagram illustrating an example of a voice recognizing apparatus. A voice recognizing apparatus 1200 includes a sentence generator 1210 and a word embedding apparatus 1230.

The sentence generator 1210 generates an input sentence by recognizing a voice of a user.

The word embedding apparatus 1230 detects an unlabeled word included in the input sentence generated by the sentence generator 1210, and obtains first feature vectors corresponding to labeled words included in the input sentence. The word embedding apparatus 1230 obtains a second feature vector corresponding to the unlabeled word based on the first feature vectors. The word embedding apparatus 1230 may correspond to the word embedding apparatuses described above.

The voice recognizing apparatus 1200 generates interpretation information corresponding to the input sentence based on the first feature vectors and the second feature vector.

The word embedding apparatus 1000, transceiving interface 1010, word embedding apparatus 1100, input interface 1110, first model 1130, output interface 1170, searcher 1153, second model 1156, voice recognizing apparatus 1200, sentence generator 1210, word embedding apparatus 1230, described in FIGS. 10-12 that perform the operations described in this application are implemented by hardware components configured to perform the operations described in this application that are performed by the hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 2-9 that perform the operations described in this application are performed by computing hardware, for example, by one or more processors or computers, implemented as described above executing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access memory (RAM), flash memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A word embedding method comprising:
receiving an input sentence;
detecting an unlabeled word in the input sentence;
embedding the unlabeled word based on labeled words included in the input sentence; and
outputting a feature vector based on the embedding.

2. The method of claim 1, wherein the embedding of the unlabeled word comprises:
searching for at least one labeled word corresponding to the unlabeled word; and
embedding the unlabeled word based on the at least one labeled word and labeled words of the input sentence.

3. The method of claim 2, wherein the searching for the at least one labeled word comprises searching for the at least one labeled word on the Internet or a dictionary database.

4. The method of claim 1, wherein the searching for the at least one labeled word comprises searching for the at least one labeled word on the Internet based on some of the labeled words in the input sentence.

5. The method of claim 1, wherein the unlabeled word comprises words other than the labeled words corresponding to a feature vector from among words of the input sentence.

6. The method of claim 1, wherein the detecting of the unlabeled word comprises:
identifying a feature vector corresponding to words of the input sentence; and
detecting a word of the input sentence as the unlabeled word, in response to a feature vector corresponding the word not being obtained.

7. The method of claim 6, wherein the identifying of the feature vector comprises identifying the feature vector of a predetermined type corresponding to the words of the input sentence by applying each word of the input sentence to a first model including a neural network.

8. The method of claim 7, wherein the embedding of the unlabeled word comprises embedding the unlabeled word by applying the unlabeled word to a second model distinguishable from the first model.

9. The method of claim 1, wherein the embedding of the unlabeled word comprises:
searching for sentences similar to the input sentence based on the labeled words; and
embedding the unlabeled word based on a sentence having a greatest similarity from among the similar sentences.

10. The method of claim 1, wherein the embedding of the unlabeled word comprises embedding the unlabeled word based on a context of the input sentence.

11. The method of claim 1, wherein the embedding of the unlabeled word comprises embedding the unlabeled word based on a relationship between labeled words of the input sentence.

12. The method of claim 1, wherein the embedding of the unlabeled word comprises:
searching for sentences similar to the input sentence based on the labeled words;
extracting at least one similar sentence having a similarity greater than a threshold from among the similar sentences; and
embedding the unlabeled word based on the at least one similar sentence.

13. The method of claim 12, wherein the extracting of the at least one similar sentence comprises extracting the at least one similar sentence having the similarity greater than the threshold by order of similarity.

14. The method of claim 1, wherein the embedding of the unlabeled word comprises detecting a feature vector corresponding to the unlabeled word using a lookup table that stores pre-generated feature vectors corresponding to unlabeled words.

15. A non-transitory computer-readable storage medium storing instructions that, when executed by a processor, cause the processor to perform the method of claim 1.

16. A voice recognizing method comprising:
generating an input sentence by recognizing a voice;
detecting an unlabeled word in the input sentence;
obtaining first feature vectors corresponding to labeled words in the input sentence;
obtaining a second feature vector corresponding to the unlabeled word based on the first feature vectors; and
generating interpretation information corresponding to the input sentence based on the first feature vectors and the second feature vector.

17. The method of claim 16, wherein the detecting of the unlabeled word comprises detecting a word included in the input sentence as the unlabeled word, in response to a first feature vector corresponding to the word not being obtained.

18. The method of claim 17, wherein the obtaining of the first feature vectors comprises obtaining the first feature vector corresponding to each word of the input sentence by applying the labeled words included in the input sentence to a first model including a neural network.

19. The method of claim 16, wherein the obtaining of the second feature vector comprises embedding the unlabeled word by applying the unlabeled word to a second model distinguishable from the first model, based on the first feature vectors.

20. A word embedding apparatus comprising:
a transceiving interface configured to receive an input sentence; and
a processor configured to detect an unlabeled word included in the input sentence and to embed the unlabeled word based on labeled words included in the input sentence,
wherein the transceiving interface is further configured to output a feature vector based on the embedding.

21. The apparatus of claim 20, wherein the processor is further configured to search for at least one labeled word corresponding to the unlabeled word on the Internet or a dictionary database and to embed the unlabeled word based on the retrieved at least one labeled word and the labeled words in the input sentence.

22. The apparatus of claim 20, wherein the processor is further configured to obtain a feature vector corresponding to each word in the input sentence and to detect a word in the input sentence as the unlabeled word, in response to the feature vector corresponding the word not being obtained.

23. A voice recognizing apparatus comprising:
a sentence generator configured to generate an input sentence by recognizing a voice;
a word embeder configured to detect an unlabeled word in the input sentence, to obtain first feature vectors corresponding to labeled words in the input sentence, and to obtain a second feature vector corresponding to the unlabeled word based on the first feature vectors; and
a processor configured to generate interpretation information corresponding to the input sentence based on the first feature vectors and the second feature vector.

24. A digital device comprising:
an antenna;
a cellular radio configured to transmit and receive data via the antenna according to a cellular communications standard;
a touch-sensitive display;
a memory configured to store instructions; and
a processor configured to execute the instructions to detect an input sentence through the cellular radio, to detect an unlabeled word in the input sentence, to obtain first feature vectors corresponding to labeled words in the input sentence, to obtain a second feature vector corresponding to the unlabeled word based on the first feature vectors, and to display interpretation information on the touch-sensitive display corresponding to the input sentence based on the first feature vectors and the second feature vector.
